(19) United States
(12) Patent Application Publication
(10) Pub. No.: US 2026/0028697 A1
(43) Pub. Date: Jan. 29, 2026

(54) Pyrometallurgical process and plant for selective recycling of molybdenum in the reprocessing of spent petrochemical catalysts

(71) Applicant: ECO'RING, Chambéon (FR)

(72) Inventors: Jean-Luc Roth, Metz (FR); Lionel Picard, Feurs (FR)

(21) Appl. No.: 18/845,598

(22) PCT Filed: Mar. 11, 2022
(86) PCT No.: PCT/FR2022/050449

§ 371 Date: Mar. 17, 2025

(51) Int. Cl. C22B 34/32; C01G 39/02

(52) U.S. Cl. CPC C22B 34/325; C01G 39/02

(57) ABSTRACT

For treating petrochemical catalysts for the selective extraction of molybdenum therefrom, a plant and a process are proposed for extracting the molybdenum by charging a batch of catalysts to a rotary kiln of which the refractory is heated or preheated to a high temperature, and setting the kiln in rotation so that the catalyst charge undergoes constant renewal of the surface in contact with the superheated refractory. The catalyst charge is brought to temperatures of the order of 1300° C. (1250 to 1350° C.), which allow around 95% of the molybdenum present to sublime.

The present invention relates to a treatment process for recycling spent petrochemical catalysts containing nickel Ni, molybdenum Mo, and cobalt Co, as well as, if appropriate, vanadium V, bismuth BI, or tungsten W.

In chemistry and petrochemistry, catalysts are used to initiate and maintain chemical reactions. The catalysts contain nickel Ni, molybdenum Mo and cobalt Co.

During the use thereof, the catalysts are charged with different inhibitor substances, including carbon C, hydrocarbons HC and sulfur S, and in some cases vanadium V or sodium Na. The inhibitor substances are detrimental to the primary function of the catalysts.

Thereby, periodically, the catalysts are discharged from the reactors, to be regenerated. In the meantime, same are replaced either by new catalysts or by regenerated catalysts. Regeneration is a light heat treatment for extracting pollutants to an acceptable level for the catalysis operation. However, after a plurality of regeneration cycles, it is no longer possible to sufficiently reduce the pollutant content of the catalysts. It is possible to monitor the pollutant content of the catalysts by analyzes carried out at each regeneration step on a sample of the catalysts used and regenerated.

Thereby, as the regeneration operations progress and depending on the inhibitors accumulated, the catalysts reach the end of the life thereof, regeneration no longer serving to sufficiently reduce the pollutant content. The catalysts should then be treated in order to extract the greatest amount of valuable elements contained in the mass thereof, preferably separated element by element, which is considered to be a recycling operation. The invention intervenes at the abovementioned step of the catalyst life cycle.

The raw catalysts to be recycled are generally characterized by a support mainly consisting of porous alumina, with contents by weight of hydrocarbons HC of 0 to 25%, of sulfur S of 0 to 25% mainly in the form of metal sulfides, of fixed carbon C (the residual carbon after burning, once the ash has been removed) of 0 to 25%, and by the presence of metals Ni, Mo, Co, V and W in the form of metal sulfides.

To date, the industrial processes for treating the raw catalysts consist mainly of a first calcination step leading to roasted catalysts-commented on hereinafter-followed by a hydrometallurgy treatment (extraction with a solubilization step) or a subsequent pyrometallurgy treatment (treatment by heat and oxidation or reduction, sometimes using self-sustaining exothermic reactions).

The initial calcination step is a simple thermal step usually without a change of phase (the catalysts remain solid) and in the presence of unmodified air (no inert atmosphere in particular).

Calcination removes hydrocarbons and carbon and converts metal sulfides into metal oxides to obtain so-called roasted catalysts. The chemical compositions by weight of the roasted catalysts are then typically from 3 to 20% for Mo, 0 to 4% for Ni, 0 to 4% for Co, 0 to 20% for V, 0 to 15% for W and 0 to 5% for BI. Mo is, after calcination, in the form of MoO3 (molybdenum trioxide), Ni is in the form of NiO (nickel monoxide), Co is in the form of CoO (cobalt monoxide) or Al2CoO4 (cobalt aluminate), V is in the form of vanadium mixed-oxides, W is the form of WO3 (tungsten trioxide), and Bi is in the form of oxide.

The calcination step is followed, in known techniques, either by a conversion by hydrometallurgical route or by a conversion by pyrometallurgical route.

A known conversion of the product of the calcination of the raw catalysts to be recycled by hydrometallurgical route begins with an attack of the roasted catalysts by sodium route aimed at dissolving the metals such as Mo, V and W. The sodium solution is then treated chemically, e.g. by ammoniacal route, to restore, after a new calcination, oxides MoO3, V2O5 and WO3.

The supplementary fraction of the roasted catalysts containing alumina, Ni and Co, or even Bi, is then either upgraded by recycling the alumina content in cement plants, but then the Ni and Co contained are not separated and recycled, or melted with addition of lime to separate the alumina in the form of calcium aluminate and the Ni and Co in a precipitated metal, the bismuth then remaining at the bottom of the kiln. A third solution is to dump the supplementary fraction.

Typically, the yields of recovery and reuse of metals are at most 85% for the metals Mo, Ni and Co.

Alternatively to the hydrometallurgical route, a known conversion of the product of the calcination of the raw catalysts to be recycled by the pyrometallurgical route begins with a reducing melting suitable for the type of catalysts NiMo, CoMo and NiCoMo. Alumina is converted into the form of lime aluminate with a low melting point-typically less than 1550° C.—with precipitation of the metals Ni, Mo and Co by addition of iron as reducing agent. For the ferroalloy part, which may be FeNiMo, FeNiCoMo or FeCoMo, same has to be remelted in oxidative mode to remove phosphorus from the catalysts so that FeNiMo, FeNiCoMo and FeCoMo alloys contain less than 0.1% by weight of phosphorus, which is a condition for same to be marketable. Typically, the yields of recovery and reuse of metals are at most 85% for Mo, Ni and Co.

Moreover, the economic lines for reuse FeNiMo and FeCoMo ferroalloys are not very permissive to residual Co and Ni contents, respectively, since a maximum value of 0.5% by weight of Co is expected for FeNiMo alloys, and a maximum value of 0.5% by weight of Ni for FeCoMo alloys. In fact, FeNiCoMo alloys containing both several percent of Ni and Co are difficult to recycle.

All industrial processes known and currently used, whether based on hydrometallurgy or pyrometallurgy, use multi-step processes. Same are faced with incompatibilities such as the succession of reductive melting and oxidizing melting or the mobilization of distinct techniques requiring separate skills and equipment such as calcination followed by leaching requiring intermediate cooling.

Such lines thus use processes that are expensive in terms of equipment, energy and reagents, and what is more, are not very efficient with regard to greenhouse gas emissions, polluted water or salted discharges.

The processes of said lines are complex in operation, along with transloading. Same perform poorly in terms of yields of recovery and reuse of metals and have little reuse value for alumina.

Among the metals contained in the catalysts to be recycled, molybdenum Mo is of a very particular economic interest.

The ability of molybdenum to sublimate—i.e. to pass directly from the solid phase to the vapor phase in the form of oxide MoO3—from 1100 or 1200° C. is also known, which is mentioned in a limited number of scientific publications or patent application publications. In general, industrial processes based on sublimation are commonly described with the term “fuming”.

A study published in 2007 in a Russian Journal of non-ferrous metals [by] Medvedev et al., 2007, 48, 2, p 114 studies the sublimation of molybdenum contained in used catalysts employed for the treatment of petroleum products containing sulfur, in the laboratory, in a 110 cm³ crucible electrically heated in a muffle kiln with a volume of 22,500 cm. Using charges of a few tens of grams, the study explored the sublimation yield, i.e. the proportion of molybdenum extracted, at temperatures between 100° and 1200° C., and with charge thicknesses of 2 to 5 cm. It is also proposed to use a tank kiln with heating at mid-height to maintain the upper layer at a certain temperature, and a flow rate of treated catalyst passing through the kiln suitable for optimizing the conversion.

The document U.S. Pat. No. 4,551,331A moreover mentions a separation of molybdenum contained in a stream of granules (10 mesh) subjected to pneumatic transport. The stream passes through a cyclone chamber with fuel and flame, at a temperature of up to 1600° C., before a slag condenses and the gas stream containing the separated molybdenum is brought back to 850° C., at which point impurities condense, resulting in purified molybdenum in the residual gas stream.

The process requires a very long reactor length, high gas velocities, and the presence of fusible fractions lead the materials to stick, which makes the process inefficient.

The document CN113444896A also discloses a technique for extracting molybdenum from spent catalysts, using a horizontal tube with an internal propulsion screw, the walls of the tube being brought to a high temperature by electric or flame heating in annular external chambers, air enriched, if appropriate, with oxygen passing in backflow. Such solution is demanding because of the screw which pushes the material into the tube. In the end, the performance is disappointing.

In such context, the subject matter of the invention is to selectively extract molybdenum in the form of MoO3 oxide dust by sublimation—or fuming—which is such as to allow for good recycling of the molybdenum contained in the catalysts. The subject matter of the invention is therefore to recycle the elements Ni and Co without metallurgical residual constraint, contrary to what is faced with in current pyro-metallurgical processes producing FeNiMo, FeCoMo and FeNiCoMo alloys.

To this end, the invention proposes a kiln plant and process. The term kiln covers the notion of reactor or converter, using heat to cause the reaction or conversion.

The plant comprises a rotary kiln coated with a layer of refractory material subjected sequentially or continuously to a heating source and then in contact with the used catalysts to be treated. Same can be a horizontal or inclined rotary converter, possibly a TBRC (Top Blowing Rotating Converter), or a rotary kiln.

The molybdenum extraction process consists in heating and, if appropriate, preheating the refractory material of the rotary kiln to a high temperature (1400 to 1650° C.) and then charging into the kiln, a quantity of catalysts, the volume of which does not exceed 20% of the volume of the kiln. The kiln is then set in constant or interrupted rotation, in order to preferably renew without interruption, the catalyst material in direct contact with the superheated refractory. The rotation is always in the same direction or is a succession of oscillations in one direction and then in the opposite direction.

The catalyst charge is thus brought to temperatures on the order of 1300° C. (1250 to 1350° C.) at the end of the heating time. The process is either cyclic or semi-continuous.

The catalyst charge constantly renews the surface in contact with the superheated refractory. The catalyst charge is brought to temperatures on the order of 1300° C. (1250 to 1350° C.) making it possible to sublime about 95% of the molybdenum contained therein.

Thereby, the invention consists of a process for the treatment of spent industrial catalysts containing nickel, cobalt, vanadium, tungsten, bismuth and molybdenum, consisting in charging the catalysts into a rotary kiln, the refractories of which are heated beforehand to at least 1250° C., entraining by a gas stream a sublimated material in contact with said refractories and in condensing said material outside the rotary kiln. The gas stream is preferably an oxidizing stream, for converting any molybdenum sulfide present into molybdenum oxide which sublimates.

Advantageously and optionally,
the refractories are heated beforehand to at least 1300° C.
the volume of the catalyst charge is less than 20% of the internal volume of the rotary kiln. As a result, it is possible to preserve a large surface area of free refractory that radiates toward the catalysts present in the kiln, and to prevent part of the charge from ever reaching the surface, and thereby to be less heated.
A kiln temperature, as measured with a sensor at a significant location, or a temperature set by an operator and thereby forming a setpoint temperature, is raised or maintained by means of a oxygenated gas burner with an excess oxygen supply or by an electrical source, and a material is added in either continuously while the burner is heating, or once after the burner has allowed the kiln refractories to be superheated.
In the latter case, heating of the refractories to more than 1600° C. while the kiln is empty is alternated with a treatment of a quantity of material which is then extracted before new heating of the refractories to more than 1600° C.
The rotary kiln is a rotary converter which can be a TBRC kiln but which can also be a horizontal, rotary converter.
The rotary kiln may also be a rotary Kiln.
The catalysts are first calcined—preferentially in the form of low temperature roasting, on the order of 800° C.
the catalyst charge is then melted in a converter containing a liquid ferronickel alloy hot heel (pied de bain), and wherein sources of iron oxide and lime are added.

FIG. 1 shows in general a complete treatment line according to the invention.

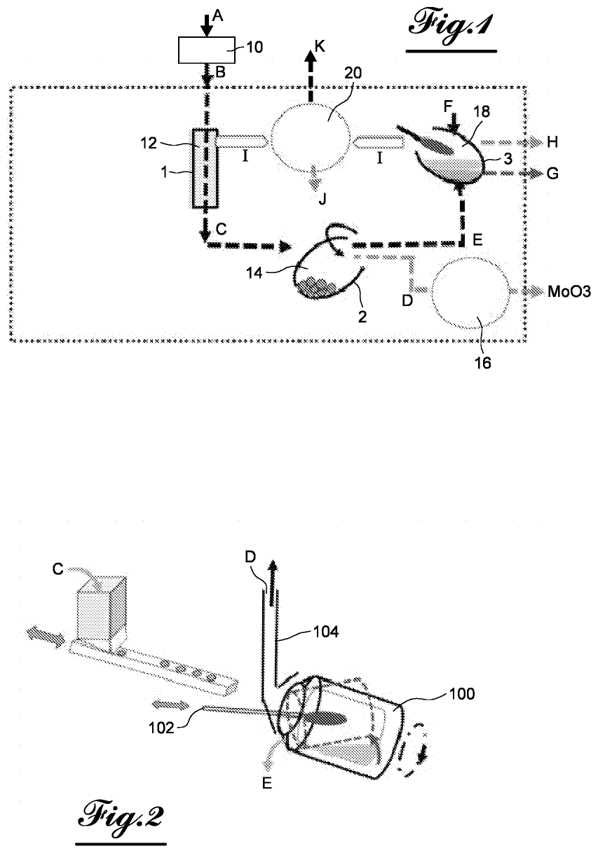

FIG. 2 illustrates a plant for a first embodiment of the invention.

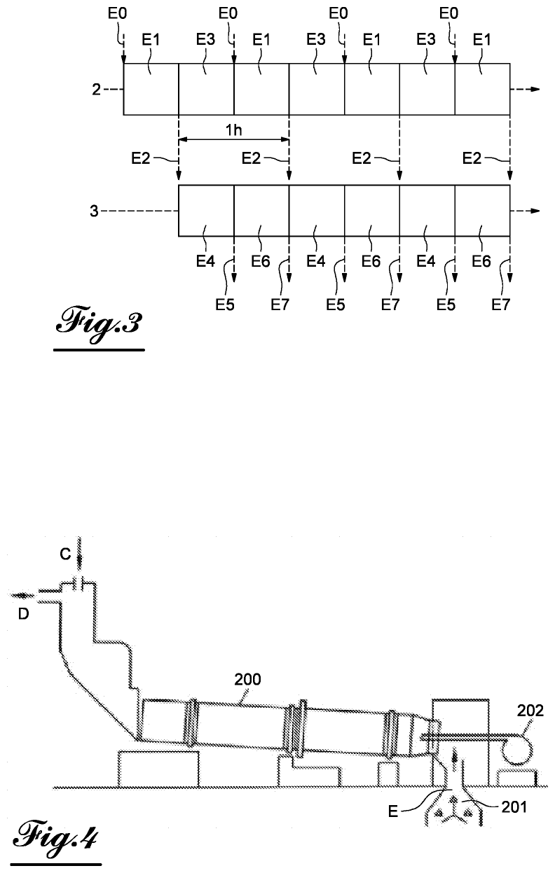

FIG. 3 shows an aspect of the implementation of the invention.

FIG. 4 illustrates a plant for a first embodiment of the invention.

Subject matters, features and advantages of the invention will become clear from the following description, given only as examples, but not limited to, given in reference to the enclosed drawings, wherein:

FIG. 1 shows a complete treatment line for untreated spent catalysts such as NiMo, identified by A. The line according to the invention is based on the extraction of molybdenum by sublimation.

The line includes a de-oiling step 10 leading, from the untreated spent catalysts A to de-oiled catalysts B followed by a roasting step 12 of the de-oiled catalysts

B, the latter being intended to remove most of the carbon C, hydrocarbons HC and sulfur pollutants. The roasting step 12 is carried out in a column 1 and serves to obtain roasted catalysts C. Said step can be carried out in one example with a rate of 1.5 t/h of treated de-oiled catalysts B, producing 1.0 t/h of roasted catalysts C, leaving the roasting tunnel kiln at 800° C. and comprising, by weight, 2.8% Ni, 13% Mo, 1.5% Co, less than 1% C and 0.3% S. The difference in material is extracted in the form of gas.

The roasted catalysts C are then subjected to dry treatment at high temperature 14-1300° C.—in a rotary kiln 2, to obtain the sublimation of the molybdenum, which leads to the extraction of a gas D from the kiln, containing 95% of the Mo contained in the roasted catalysts C. Thereby, 186 kg of MoO3 trioxide are recovered per 1 t of roasted catalysts C containing approximately 13% Mo by weight.

It is preferable to carry out the roasting step 12 beforehand and separately from the step of dry treatment at high temperature 14 so as not to pollute the molybdenum oxide powder with carbonaceous and/or sulfide residues. Thereby, the rotary kiln 2 is preferably a piece of equipment separate from the tunnel kiln 1.

Similarly, the high temperature dry treatment step 14 as such should preferably be carried out under conditions that prevent the flight of fine catalyst particles (particle sizes of 0.5 to 2.5 mm)—more particularly fines of less than 1 mm. Thereof requires that the flow rate of gas passing through the rotary kiln 2 be limited. Thereof applies more particularly to the flue gases from the burner possibly heating the rotary kiln 2, if such a burner is used.

Moreover, carrying out the dry high temperature treatment step 14 rapidly at the exit of the roasting step 12 allows the heat contained in the roasted catalysts C, which are at that time at 700-800° C., to be recovered At the outlet of the high temperature dry treatment 14, the gases D are isolated and condensed during a gas treatment step 16, which serves to recover a powder essentially comprising MoO3. For 1 ton of roasted catalysts C, 186 kg of molybdenum oxide powder are obtained.

The solid residues E from the rotary kiln 2 are transferred to a second rotary kiln 3 for a melting step 18 with a hot heel (pied de bain) of ferronickel alloy FeNi and additions F of lime and iron oxide, at 1500-1600° C. There is then a separation of a nickel ferroalloy G on the one hand, in a quantity of 87 kg per ton of treated roasted catalysts C, and of alumina and lime H on the other hand, in an amount of 1.4 tons per ton of treated roasted catalysts C. Ferronickel alloy comprises about 29% nickel by weight.

It is recommended to carry out the melting step 18 upon leaving the sublimation reactor, i.e. the rotary kiln 2, as soon as the very high temperature treatment step 14 is completed, so as to recover the heat contained in the solid residues at 1300° C., i.e. a significant part of the heat of the melting.

The gases I resulting from the roasting step 12 or from the melting step 16 are treated together or separately during a purification step 20 so as to isolate the sulfates J and to obtain purified gases K.

FIG. 2 in a first version of the process, represented in FIG. 2, and wherein the process is implemented discontinuously, the Mo sublimation process is carried out in a rotary kiln which is a TBRC 100 (Top Blowing Rotating Converter). As an example, a TBRC 100 converter with a melting capacity of 10 t, an internal diameter of about 1.8 m, and a useful height of 3.6 m. Same has a single opening, shown in the figure turned to the left and slightly turned upwards. The body thereof consists of a cylinder of revolution, with at one end the opening which has just been mentioned and at the other a bottom essentially perpendicular to the axis of the cylinder. During operation, the axis of the cylinder is inclined by 20° to 40° relative to the horizontal, a preferred value of the inclination being 20°. The TBRC 100 is heated so that the temperature of the refractory is raised to 1400° C. and 1 ton of roasted catalysts C are charged thereto, with batch charging while continuing the rotation of the tank.

The treatment lasts 1 h and the temperature of the material present in the kiln is maintained by means of a gas-oxygen burner flame 102, oriented in the internal volume of the kiln, above the treated material, on the surface of the latter or in the latter, operating at a power on the order of 1,000 KW, or a little higher depending on the quality of the insulation of the tank of the TBRC 100.

Alternatively, the converter can be heated by an electrical source, such as a resistor or a plasma torch, with a power on the order of 500˜750 kW.

In all cases, care is taken to ensure that the kiln is traversed by a gas flow rate (combustion fumes and/or air) of at least 250 Nm3/h, and preferably on the order of 400˜500 Nm3/h. The value of 400 Nm3/h corresponds to the flow rate of combustion gas from the oxygas burner operating at 1000 KW with an excess of oxygen, for oxidizing the molybdenum possibly present in the form of molybdenum sulfide.

The kiln rotates at a speed of 0.5 to 2 rpm and typically 1 rpm. For a converter with a diameter of 1.8 m, the perimeter of the inner wall is 5.7 m and a rotation speed of 1 rpm gives a displacement at the wall of nearly 10 cm/s.

The stream of gaseous molybdenum oxide, output and entrained by the irrigation flow, is captured in the form of gas D by a pipe 104, and cooled by suction of cold air, wherein the molybdenum oxide condenses in the form of a fine powder. The remaining catalyst is discharged as solid residue E by tilting the TBRC 100 kiln and immediately directed to another converter comprising a bath of FeNi alloy, wherein same is melted, with a concomitant addition of iron oxide and lime, as explained in relation to FIG. 1. The heat input by flame can be interrupted to discharge the solid residue.

At the same time, the TBRC 100 is recharged and a new batch of roasted catalysts C to be treated is added into the internal volume thereof.

Alternatively to an inclined kiln with a flame brought in from the top, as has just been described, it is also possible to use a horizontal converter, always operating in batches (thus discontinuously), and with a flame brought in from the side, to heat the gas above the material to be treated without aiming at same directly.

FIG. 3 In a second version of the process, the rotary kiln 2 (FIG. 1) is preheated so as to obtain a refractory temperature of 1600˜1650° C. Then, once said temperature is reached, 1 ton of roasted catalysts are charged in a single pour into the kiln, during a charging step E0. The tank is then kept in rotation for 30 minutes, and during said time the volume of the tank is irrigated with air or possibly with oxidizing gas (the oxygen O2 being necessary to oxidize the molybdenum sulfide possibly present), without adding any additional material to be treated nor adding more heat. Thereby, a sublimation step E1 is carried out.

In such version, the sublimation phase is thus carried out in batches, in ½ h., without a burner and without an electric heat source, by thermal heating of the highly overheated refractory walls.

The treated catalysts are then discharged during a transfer step E2 and directed to the rotary kiln 3 for melting. At the same time, iron oxide and lime are added to the rotary kiln 3 for the melting.

Meanwhile, the sublimation kiln—the rotary kiln 2-is empty and is heated by an oxygas burner or by an electric source, with a power level on the order of 2,000 kW gas or 1000˜1400 KW electric, to again reach a refractory temperature of 1600˜1650° C., which is done within 30 minutes. Such step is a heating step E3

A new batch of catalysts, typically with a weight of one ton, is then charged during a charging step E0 and subjected to the molybdenum sublimation reaction for 30 minutes.

During said time, the treated catalysts undergo a melting step E4 of about half an hour in the rotary kiln 3, in the presence of lime and iron oxide and a hot heel (pied de bain) of ferronickel alloy, at the end of which a first slag is removed from the tank during a first de-slagging step E5, then a refining of about half an hour is carried out during a step E6, before a second slag is also removed from the tank of the rotary kiln 3, during a second de-slagging step E7, at the end of which the ferronickel hot heel (pied de bain) is kept in the rotary kiln 3.

The use of two reactors of the same type is advantageous in an industrial treatment line. Thereby, an industrial plant equipped with three TBRCs—two in operation and one in reserve or being refurbished—can operate continuously, and avoids production stoppages related to refractory repairs and refurbishment.

FIG. 4 As mentioned hereinabove, the sublimation phase can also be carried out in a rotary Kiln, a diagram of which is given in FIG. 4 hereinafter. There is a continuous charging of the roasted catalysts C through the top of one end of a tunnel 200 which is generally a long cylinder, and a continuous discharging E, through the bottom of the other end of the tunnel, of the treated solid residue. A burner lance 202 is present near the exit end of the tunnel to project a flame into the tunnel. A gas suction outlet D is present near the inlet end of the tunnel, at the top. The tunnel 200 is in permanent rotation always in the same direction, over 360°, which mixes the contents thereof. The tunnel 200 is inclined: the entrance of the matter to the left of the figure is at a height, higher than the outlet of the matter to the right of the figure. The inclination is usually 1 to 5%, with a typical value e.g. of 3%. The rotation takes place about the axis of the tunnel 200. A gas inlet 201 is present near the burner lance 202 and the continuous discharge.

More particularly, the treatment of 1 t of catalysts in 1 h can be carried out in a Kiln with an internal diameter of 1.2 m, a length of 11 m, i.e. a volume of 12.4 m3, into which a flow rate of 1 t/h of catalysts is continuously charged. The rotation can be 0.5 to 2 rpm, a typical example being a value of 1 rpm. With a catalyst density close to 1 and for a residence time of 1 h, the 1 t charge present in the kiln occupies a volume of about 1m3, i.e. about 8% of the volume of the kiln. The kiln is heated using a gas burner flame, operating at a power on the order of 1000 kW. A gas stream with excess oxygen O2 (compared to what is needed to burn the fuel) entrains the gaseous fraction forming above the treated catalysts; from the gas inlet 201. The excess oxygen makes it possible, as before, to oxidize the molybdenum sulfide which may be present.

Alternatively to the complete rotation of the rotary Kiln, the advancement and mixing of the material can also be ensured by an oscillation of the kiln: thereby, an axis of rotation is defined, and a maximum amplitude of rotation about the axis, of less than one complete revolution. The direction of rotation is reversed when the angle defining the maximum amplitude of rotation is reached, and thereby an angular displacement is alternated in one direction and then in the other, which mixes the material added into the kiln and allows the whole of the latter to be close to the free surface exposed directly to the gas present in the kiln at one time or another during the residence thereof in the kiln and to be in direct contact or very close contact with the overheated walls of the kiln at another time during the residence thereof in the kiln.

The walls of the kiln can be equipped with porous bricks connected to a gas injection circuit, which make possible the injection of gas into the material present in the kiln, which contributes, in addition to the rotation, to stirring the material and leading to a significant renewal of the fraction of the material which is close to the free surface, and same which is in direct contact or very close contact with the overheated walls.

In all cases, the on-line melting of the sublimated catalyst at 1300° C. has a significant energy saving, as the melting can be carried out efficiently in a rotary converter or a rotary Kiln.

In summary, to treat petrochemical catalysts, so as to selectively extract molybdenum therefrom, a molybdenum extraction plant and process is proposed, consisting in charging a batch of catalysts into a rotary kiln the refractory of which is heated or preheated at high temperature, and in rotating the kiln, so that the catalyst charge constantly renews the surface in contact with the superheated refractory. The catalyst charge is brought to temperatures on the order of 1300° C. (1250 to 1350° C.) making possible to sublime about 95% of the molybdenum contained.

1. A process of treatment of spent industrial catalysts containing molybdenum, consisting in charging the catalysts into a kiln the refractories of which are heated to at least 1250° C., in entraining by a gas flow, a gaseous fraction forming in the kiln and in condensing said fraction outside the kiln, characterized in that the kiln is rotating.

2. The treatment process according to claim 1, according to which, in successive cycles, heating of the refractories to more than 1600° C. while the kiln is empty is alternated with a treatment by the heat stored in the refractories of a quantity of catalysts from which a solid residue is then extracted before a new vacuum heating cycle followed by a treatment of a new quantity of catalysts.

3. The treatment process according to claim 2, wherein the kiln is a rotary converter, either inclined or horizontal.

4. The treatment process according to claim 1, wherein the catalysts to be processed are continuously added into the kiln, and a solid remainder is continuously extracted.

5. The treatment process according to claim 4, characterized in that the kiln is a rotary Kiln.

6. The treatment process according to one of claims 1 to 5, according to which the catalysts are priorly subjected to a calcination.

7. The treatment process according to one of claims 1 to 6, according to which a solid residue of the catalysts is then melted in a converter containing a hot heel (pied de bain) of liquid ferronickel alloy, and wherein sources of iron oxide and lime are added.

8. The treatment process according to one of claims 1 to 7, according to which the refractories are priorly heated or maintained at least 1300° C.

9. The treatment process according to one of claims 1 to 8, according to which the volume of the catalyst charge is kept below 20% of the internal volume of the kiln.

10. The treatment process according to one of claims 1 to 9, wherein the kiln is heated by means of an oxygen gas burner with an excess oxygen supply or by means of an electrical source.

11. The treatment process according to one of claims 1 to 10, according to which the rotation is always in the same direction or is a succession of oscillations in one direction and then in the opposite direction.
